(19) United States
(12) Patent Application Publication
(10) Pub. No.: US 2024/0110416 A1
(43) Pub. Date: Apr. 4, 2024

(54) Stepper Doorstopper Device

(71) Applicant: Carol Newman, Spring Valley, CA (US)

(72) Inventor: Carol Newman, Spring Valley, CA (US)

(21) Appl. No.: 18/357,438

(22) Filed: Jul. 24, 2023

Related U.S. Application Data
(60) Provisional application No. 63/412,631, filed on Oct. 3, 2022.

(51) Int. Cl. E05C 17/54

(52) U.S. Cl. CPC E05C 17/54

(57) ABSTRACT

The present invention relates to a novel doorstopper device. The device is a doorstop shaped like various shoes, such as, but not limited to, sandals, flip flops, wedge shoes, tennis shoes, slip-on shoes, Mary Jane shoes, moccasins, cleats, loafers, boots, baby booties, etc. The device comprises a base component with a non-slip vulcanized rubber sole component to keep the doorstopper device in place. The doorstopper device can be available in multiple opaque colors or can be transparent. The doorstopper device can be packaged in a pack of two or more for application to any type of door or gate.

### CROSS-REFERENCE TO RELATED APPLICATION

The present application claims priority to, and the benefit of, U.S. Provisional Application No. 63/412,631, which was filed on Oct. 3^{rd}, 2022, and is incorporated herein by reference in its entirety.

### FIELD OF THE INVENTION

The present invention relates generally to the field of doorstopper devices. More specifically, the present invention relates to an improved doorstopper device that provides users with a unique doorstop shaped like different styles of shoes, such as sandals, wedge shoes, tennis shoes, moccasins, etc. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in doorstopper devices. Generally, standard doorstops may be ineffective at keeping a door propped open for entry, ventilation, etc. However, without a doorstop, users may be unable to enter a door while their hands are full. Furthermore, inadvertently bumping into a door can be painful.

Conventional doorstoppers are unattractive and unappealing. These doorstoppers prevent users from matching décor or utilizing unique items to prop open a door. As such, a unique doorstopper to prop open doors and to be visually appealing is needed.

Therefore, there exists a long-felt need in the art for a doorstopper device that provides users with a unique doorstop shaped like different styles of shoes, such as sandals, wedge shoes, tennis shoes, moccasins, etc. There is also a long-felt need in the art for a doorstopper device that functions like a typical doorstop. Further, there is a long-felt need in the art for a doorstopper device that can be packaged together in a kit for application to multiple doors in a home, office, etc. Moreover, there is a long-felt need in the art for a device that utilizes a non-slip, vulcanized rubber base to keep the doorstop in place. Further, there is a long-felt need in the art for a doorstopper device that includes numerous different sizes and styles to accommodate any type of door or gate. Finally, there is a long-felt need in the art for a doorstopper device that is decorative and effective at keeping a door propped open for entry.

The subject matter disclosed and claimed herein, in one embodiment thereof, comprises a doorstopper device. The device is a doorstop shaped like various shoes, such as, but not limited to, sandals, flip flops, wedge shoes, tennis shoes, slip-on shoes, Mary Jane shoes, moccasins, cleats, loafers, boots, baby booties, etc. The device comprises a base component with a non-slip vulcanized rubber sole component to keep the doorstopper device in place. The doorstopper device can be available in multiple opaque colors or can be transparent. The doorstopper device can be packaged in a pack of two or more for application to any type of door or gate.

In this manner, the doorstopper device of the present invention accomplishes all of the foregoing objectives and provides users with a device that effectively props open a door. The device keeps areas ventilated or a door kept open for transporting items with ease into a home or other building. The device fits most standard doors or gates and can be manufactured in multiple designs and styles based on a user's preferences.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a doorstopper device. The device is a unique and fun doorstop shaped like various shoes and shoe designs, as is known in the art. The doorstopper device comprises a base component with a non-slip vulcanized rubber sole component to keep the doorstopper device in place under a door edge.

This invention provides an improvement in doorstops, and its object is to provide a simple and easily-manipulated device for effectively holding a door or gate open at any point in its range of movement or swing. The doorstopper device is a decorative device that can be utilized on doors, gates, etc., or any other suitable door as is known in the art, depending on the needs and/or wants of a user. In one embodiment, the doorstopper device is manufactured in varying sizes and shapes to accommodate the various styles and sizes of doors and gates available.

In one embodiment, the doorstopper device is shaped as various shoes as is known in the art. The doorstopper device can be shaped as any suitable shoe, depending on the needs and/or wants of a user. For example, the various shoe shapes can be, but are not limited to, sandals, flip flops, wedge shoes, tennis shoes, slip-ons, Mary Jane shoes, moccasins, cleats, loafers, boots, baby booties, high heels, athletic shoes, etc., or any other suitable shoes or shoe designs as is known in the art, depending on the needs and/or wants of a user.

In one embodiment, the doorstopper device comprises a base component which is shaped as the shoe design. The base component comprises a bottom and opposing side walls which form the sides of the shoe. The base component also comprises a back wall which forms the heel portion of the shoe and a front wall which forms the toe and tongue portion of the shoe. The back wall, opposing side walls, and front wall come together to form a circular opening at the top of the device, much like a conventional shoe (i.e., where a user would insert their foot). The opening does not have to be circular and can be any suitable shape as is known in the art, such as oval, rectangular, etc. In one embodiment, the back wall, opposing side walls, and front wall come together without forming an opening, but create a solid base component.

In one embodiment, the base component comprises various accessory components to make the base component resemble a shoe. For example, the base component can comprise eyelets and laces, high heels, buckles and straps, fur lined walls, tassels, decorations, etc., or any other suitable accessory components as is known in the art, depending on the needs and/or wants of a user.

In one embodiment, the front wall and opposing side walls near the toe portion of the shoe are inclined, such that they gradually-increase inclination from the bottom to the top of the shoe. This gradual inclination allows the device to engage a bottom of the door and allows the device to be inserted under a door. Specifically, the bottom wall is generally flat and extends the entire length of the device and constitutes a bottom of the doorstop. The top of the device comprising the front wall forms a wedge-shaped surface extending from a toe portion of the device to the extreme other end, with the toe portion being reduced in thickness as much as is compatible with strength for the device. This reduced end (i.e., toe portion) is of such thickness as to be easily inserted under a door between the same and the floor. Further, by pushing the thin end (i.e., toe portion) foremost under the door, the wedge-shaped surface of the tongue portion will ultimately catch the under edge of the door and will hold the door firmly in place, especially against any force tending to push the door toward the thicker end of the doorstop. To a lesser extent the doorstopper device will prevent the door from being moved toward the thinner end of the doorstop.

In one embodiment, a sole component is secured to the generally flat, bottom wall. The sole component comprises a vulcanized rubber, non-slip material for contacting the floor. In one embodiment, the sole component comprises lateral corrugations to form teeth, which are intended to rest directly upon the floor and serve as a gripping-surface for contact with the floor. It is evident that any other form of gripping surface might be used and that suitable material other than vulcanized rubber might be employed as is known in the art. Further, in one embodiment, the sole component is not utilized and the bottom wall is utilized for the purpose and either left plain or variously scored to constitute a gripping-surface for the device.

In one embodiment, the sole component is secured to the base component via any suitable securing means as is known in the art, such as, but not limited to, adhesives, glue, screws, bolts, etc.

Preferably, however, the sole component with the vulcanized rubber, non-slip material and lateral corrugations are utilized, since the sole component will not only grip almost any floor surface but will yield slightly and therefore will cause the doorstop to wedge more certainly under the door. Furthermore, by pushing the thin end (i.e., toe portion) foremost under the door, the wedge-shaped surface of the front wall will ultimately catch the under edge of the door and, because of the resilient non-slipping sole component, the doorstop will hold the door firmly in place, especially against any force tending to push the door toward the thicker end of the doorstop.

In one embodiment, the doorstopper device can be manufactured in multiple opaque colors to match various brands and styles of shoes, as well as to complement a user's décor. Further, the doorstopper device can be transparent, depending on the needs and/or wants of a user.

In one embodiment, the doorstopper device can be packaged as a kit and thus may come in a pack of two or more shoe devices for application to any size, style or type of door or gate, as is known in the art. Specifically, multiple doorstopper devices can be packaged together, such as packaging two shoe doorstopper devices in a shoe box, similar to a conventional pair of shoes. Further, the doorstopper device can have two or more of the same style of shoe packaged together or the doorstopper device can have two or more different styles of shoes packaged together, depending on the needs and/or wants of a user.

In operation, a user simply uses his/her foot to push the doorstopper device under a door. Specifically, the doorstopper device is inserted between the lower edge of a door and the floor via the toe portion of the device. Once in position with the gripping-surface next to the floor, the door is effectively propped open via the device. Thus, the doorstopper device keeps areas ventilated or allows for transporting items with ease into a home or other building through a doorway. Further, a user need not stoop down and use his/her hand in order to be sure that the doorstopper device is in the correct position under the door.

Generally, the doorstopper device is manufactured of vulcanized rubber or synthetic materials, such as, but not limited to, polycarbonate, polyethylene, ABS, PVC, etc., or any other suitable materials as is known in the art. In one embodiment, the base component and the sole component can be manufactured of the same material and built as one solid piece. Further, in this embodiment, the base component can comprise an additional top layer of flexible material that represents the upper of a shoe.

In yet another embodiment, the doorstopper device comprises a plurality of indicia.

In yet another embodiment, a method of keeping a door propped open for entry, ventilation, etc., is described. The method includes the steps of providing a doorstopper device comprising a base component with a non-slip vulcanized rubber sole component. The method also comprises choosing a specific style and size of the doorstopper device, depending on the needs and/or wants of a user. Further, the method comprises positioning the doorstopper device underneath the lower edge of a door and the floor. Finally, the method comprises keeping the door propped open via the doorstopper device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a perspective view of one embodiment of the doorstopper device of the present invention showing how the device resembles a shoe and is used as a doorstopper in accordance with the disclosed architecture;

FIGS. 2A-B illustrate a perspective view of one embodiment of the doorstopper device of the present invention showing how the device can be packaged as a kit and is used as a doorstopper in accordance with the disclosed architecture;

FIGS. 3A-C illustrate a perspective view of one embodiment of the doorstopper device of the present invention showing the different styles of shoes available for the device in accordance with the disclosed architecture; and

FIG. 4 illustrates a flowchart showing the method of keeping a door propped open for entry, ventilation, etc., in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a doorstopper device that provides users with a unique doorstop shaped like different styles of shoes, such as sandals, wedge shoes, tennis shoes, moccasins, etc. There is also a long-felt need in the art for a doorstopper device that functions like a typical doorstop. Further, there is a long-felt need in the art for a doorstopper device that can be packaged together in a kit for application to multiple doors in a home, office, etc. Moreover, there is a long-felt need in the art for a device that utilizes a non-slip, vulcanized rubber base to keep the doorstop in place. Further, there is a long-felt need in the art for a doorstopper device that includes numerous different sizes and styles to accommodate any type of door or gate. Finally, there is a long-felt need in the art for a doorstopper device that is decorative and effective at keeping a door propped open for entry.

The present invention, in one exemplary embodiment, is a novel doorstopper device. The device is a doorstop shaped like various shoes, such as, but not limited to, sandals, flip flops, wedge shoes, tennis shoes, slip-on shoes, Mary Jane shoes, moccasins, cleats, loafers, boots, baby booties, etc. The device comprises a base component with a non-slip vulcanized rubber sole component to keep the doorstopper device in place. The doorstopper device can be available in multiple opaque colors or can be transparent. The doorstopper device can be packaged in a pack of two or more for application to any type of door or gate. The present invention also includes a novel method of keeping a door propped open for entry, ventilation, etc. The method includes the steps of providing a doorstopper device comprising a base component with a non-slip vulcanized rubber sole component. The method also comprises choosing a specific style and size of the doorstopper device, depending on the needs and/or wants of a user. Further, the method comprises positioning the doorstopper device underneath a door. Finally, the method comprises keeping the door open via the doorstopper device.

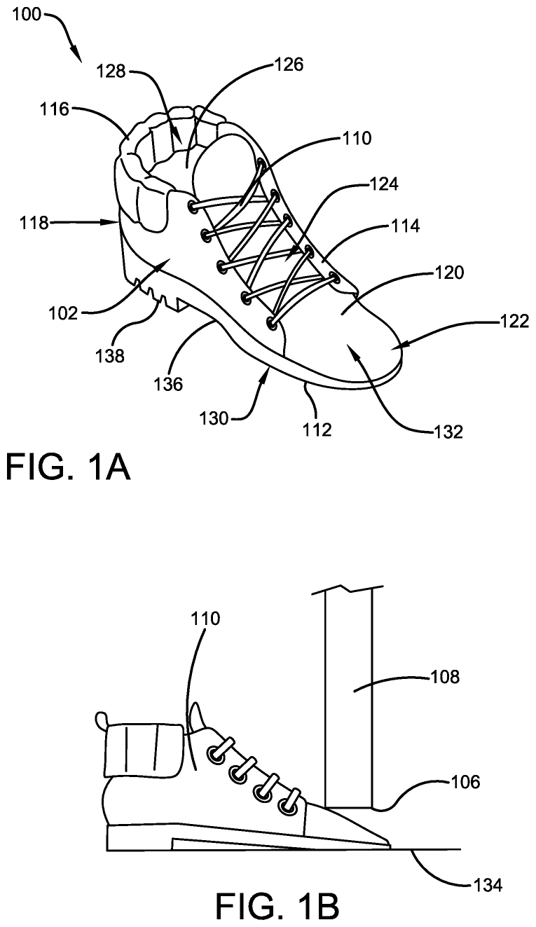

Referring initially to the drawings, FIGS. 1A-B illustrate a perspective view of one embodiment of the doorstopper device 100 of the present invention. In the present embodiment, the doorstopper device 100 is an improved doorstopper device 100 that is effective at keeping a door 108 propped open for entry, ventilation, etc. Specifically, the device 100 is shaped like various shoes 110 and shoe designs. The doorstopper device 100 comprises a base component 102 with a sole component 104 secured to it to keep the doorstopper device 100 in place under a door edge 106.

Generally, this device 100 provides an improvement in doorstops, and its objective is to provide a simple and easily-manipulated device 100 for effectively holding a door 108 or gate open at any point in its range of movement or swing. The doorstopper device 100 is a decorative device that can be utilized on doors 108, gates, etc., or any other suitable door 108 as is known in the art, depending on the needs and/or wants of a user. Furthermore, the doorstopper device 100 is manufactured in varying sizes and shapes to accommodate the various styles and sizes of doors 108 and gates available. Additionally, the device 100 utilizes any suitable shoe 110 or shoe design as is known in the art, depending on the needs and/or wants of a user.

Furthermore, the doorstopper device 100 comprises a base component 102 which is shaped as the shoe 110 or shoe design. The base component 102 comprises a bottom 112 and opposing side walls 114 which form the sides of the shoe 110. The base component 102 also comprises a back wall 116 which forms the heel portion 118 of the shoe 110 and a front wall 120 which forms the toe 122 and tongue portion 124 of the shoe 110. The back wall 116, opposing side walls 114, and front wall 120 come together to form a circular opening 126 at the top 128 of the device 100, much like a conventional shoe 110 (i.e., the opening is located where a user would insert their foot). The opening 126 does not have to be circular and can be any suitable shape as is known in the art, such as oval, rectangular, etc.

In one embodiment, the back wall 116, opposing side walls 114, and front wall 120 come together without forming an opening 126, but create a solid base component 102. In this embodiment, the doorstopper device 100 is a solid component configured in the desired shoe 110 shape.

As shown in FIGS. 1A-B, the walls 120 and 114 of the base component 102, specifically, the front wall 120 and the opposing side walls 114 near the toe portion 122 of the shoe 110 are inclined, such that they gradually-increase inclination from the bottom 130 to the top 128 of the shoe 110. This gradual inclination allows the device 100 to engage a bottom edge 106 of the door 108 and allows the device 100 to be inserted under a door 108. Specifically, the bottom wall 112 is generally flat and extends the entire length of the device 100 and constitutes a bottom 130 of the doorstop device 100. The top 128 of the device 100 comprising the front wall 120 forms a wedge-shaped surface 132 extending from a toe portion 122 of the device 100 to the extreme other end (i.e., the heel portion 118), with the toe portion 122 being reduced in thickness as much as is compatible with strength for the device 100. This reduced end (i.e., toe portion 122) is of such thickness as to be easily inserted under a door 108 between the same and the floor 134.

Further, by pushing the thin end (i.e., toe portion 122) foremost under the door 108, the wedge-shaped surface 132 of the tongue portion 124 will ultimately catch the under edge 106 of the door 108 and will hold the door 108 firmly in place, especially against any force tending to push the door 108 toward the thicker end (i.e., heel portion 118) of the doorstopper device 100. To a lesser extent, the doorstopper device 100 will prevent the door 108 from being moved toward the thinner end (i.e., toe portion 122) of the doorstopper device 100 as well.

Additionally, the base component 102 comprises a sole component 104. The sole component 104 is secured to the generally flat, bottom wall 112. The sole component 104 comprises a vulcanized rubber, non-slip material 136 for contacting the floor 134. Typically, the sole component 104 is secured to the base component 102 via any suitable securing means as is known in the art, such as, but not limited to, adhesives, glue, screws, bolts, ultrasonic welding, or thermal welding, etc. In one embodiment, the base component 102 and the sole component 104 can be manufactured of the same material and built as one solid piece.

In one embodiment, the sole component 104 comprises lateral corrugations 138 to form teeth, which are intended to rest directly upon the floor 134 and serve as a gripping-surface for contact with the floor 134. It is evident that any other form of gripping surface might be used and that suitable material other than vulcanized rubber might be employed as is known in the art, depending on the needs and/or wants of a user. Further, in one embodiment, the sole component 104 is not utilized and the bottom wall 116 is instead utilized for the purpose and either left plain or variously scored to constitute a gripping-surface for the doorstopper device 100.

Preferably, however, the sole component 104 with the vulcanized rubber, non-slip material 136 and the lateral corrugations 138 are utilized, since the sole component 104 will not only grip almost any floor surface 134 but will yield slightly and therefore will cause the doorstopper device 100 to wedge more certainly under the door 108. Furthermore, by pushing the thin end (i.e., toe portion 122) foremost under the door 108, the wedge-shaped surface 132 of the front wall 120 will ultimately catch the under edge 106 of the door 108 and, because of the resilient non-slipping material 136 of the sole component 104, the doorstopper device 100 will hold the door 108 firmly in place, especially against any force tending to push the door 108 toward the thicker end (i.e., heel portion 118) of the doorstopper device 100.

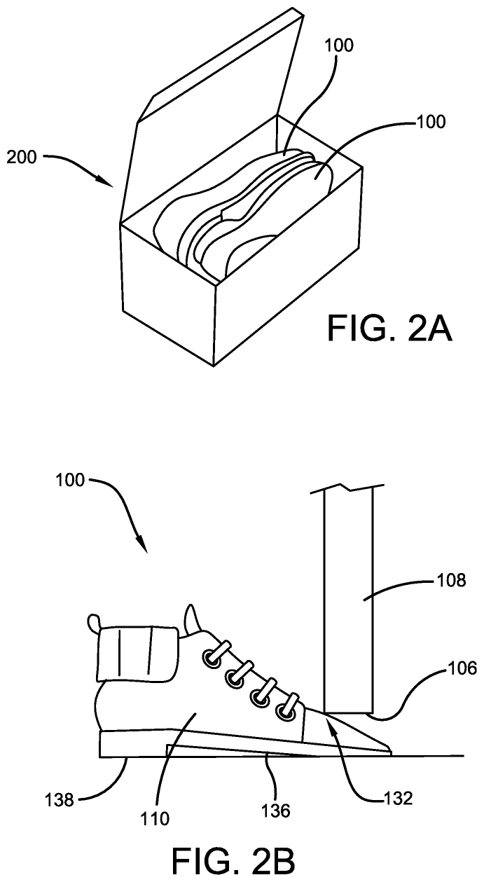

As shown in FIGS. 2A-B, the doorstopper device 100 can be packaged as a kit 200 and thus may come in a pack of two or more shoe devices 100 for application to any size, style or type of door 108 or gate, as is known in the art. Specifically, multiple doorstopper devices 100 can be packaged together, such as packaging two shoe doorstopper devices 100 in a shoe box (i.e., kit 200), similar to a conventional pair of shoes 110. Further, the doorstopper device 100 can have two or more of the same style of shoe 110 packaged together or the doorstopper device 100 can have two or more different styles of shoes 110 packaged together, depending on the needs and/or wants of a user. Any suitable number of shoes 110 and shoe styles and sizes can be packaged together as a kit 200, as is known in the art depending on the needs and/or wants of a user.

In operation, a user simply uses his/her foot to push the doorstopper device 100 under a door 108. Specifically, the doorstopper device 100 is inserted between the lower edge 106 of a door 108 and the floor 134 via the toe portion 122 of the device 100. Once in position, with the gripping-surface (i.e., non-slip material 136) next to the floor 134, the door 108 is effectively propped open via the device 100. Thus, the doorstopper device 100 keeps areas ventilated or allows for transporting items with ease into a home or other building through a doorway. Further, a user need not stoop down and use his/her hand in order to be sure that the doorstopper device 100 is in the correct position under the door 108.

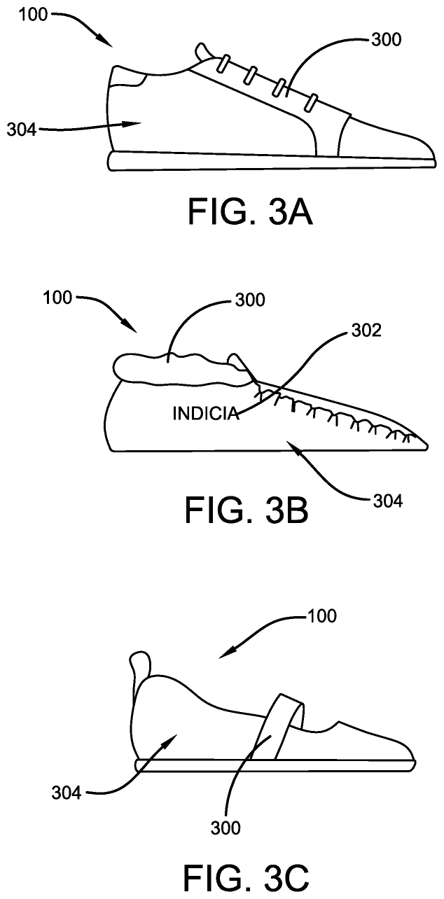

As shown in FIGS. 3A-C, the doorstopper device 100 is shaped as various shoes 110 as is known in the art. The doorstopper device 100 can be shaped as any suitable shoe 110, depending on the needs and/or wants of a user. For example, the various shoe shapes can be, but are not limited to, sandals, flip flops, wedge shoes, tennis shoes, slip-ons, Mary Jane shoes (shown in FIG. 3C), moccasins (shown in FIG. 3B), cleats, loafers, boots, baby booties, high heels, athletic shoes, sneakers (shown in FIG. 3A), etc., or any other suitable shoes 110 or shoe designs as is known in the art, depending on the needs and/or wants of a user.

Additionally, the base component 102 comprises various accessory components 300 to make the base component 102 more resemble a shoe 110 or shoe style. For example, the base component 102 can comprise eyelets and laces, high heels, buckles and straps, fur lined walls, tassels, decorations, etc., or any other suitable accessory components 300 as is known in the art, depending on the needs and/or wants of a user.

Furthermore, the doorstopper device 100 can be manufactured in multiple opaque colors, patterns, or designs, to match various brands and styles of shoes 110, as well as to complement a user's décor. However, the doorstopper device 100 can also be transparent, depending on the needs and/or wants of a user.

Generally, the doorstopper device 100 is manufactured of vulcanized rubber, aluminum, stainless steel, or synthetic materials, such as polycarbonate, polyethylene, ABS, PVC, etc., or any other suitable materials as is known in the art. In one embodiment, the base component 102 and the sole component 104 can be manufactured of the same material and built as one solid piece. Further, in this embodiment, the base component 102 can comprise a top layer 304 of canvas, cloth, leather, or other flexible material that represents the upper of a shoe 110 and would be so decorated with the accessory components 300.

Furthermore, the doorstopper device 100 comprises a plurality of indicia 302. The base component 102 of the device 100 may include advertising, a trademark, or other letters, designs, or characters, printed, painted, stamped, or integrated into the base component 102, or any other indicia 302 as is known in the art. Specifically, any suitable indicia 302 as is known in the art can be included, such as, but not limited to, patterns, logos, emblems, images, symbols, designs, letters, words, characters, animals, advertisements, brands, etc., that may or may not be doorstop, shoe, or brand related.

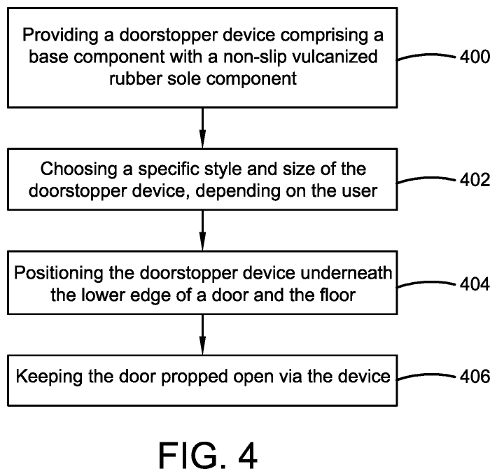

FIG. 4 illustrates a flowchart of the method of keeping a door propped open for entry, ventilation, etc. The method includes the steps of at 400, providing a doorstopper device comprising a base component with a non-slip vulcanized rubber sole component. The method also comprises at 402, choosing a specific style and size of the doorstopper device, depending on the needs and/or wants of a user. Further, the method comprises at 404, positioning the doorstopper device underneath the lower edge of a door and the floor. Finally, the method comprises at 406, keeping the door propped open via the doorstopper device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “doorstopper device”, “doorstop device”, “shoe device”, “shoe doorstopper device”, and “device” are interchangeable and refer to the doorstopper device 100 of the present invention.

Notwithstanding the foregoing, the doorstopper device 100 of the present invention can be of any suitable size and configuration as is known in the art without affecting the overall concept of the invention, provided that it accomplishes the above-stated objectives. One of ordinary skill in the art will appreciate that the doorstopper device 100 as shown in FIGS. 1-4 is for illustrative purposes only, and that many other sizes and shapes of the doorstopper device 100 are well within the scope of the present disclosure. Although the dimensions of the doorstopper device 100 are important design parameters for user convenience, the doorstopper device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A doorstopper device adapted to be inserted between a lower edge of a door and a floor surface, the doorstopper device comprising:
a base component, wherein the base component is shaped like a shoe.

2. The doorstopper device of claim 1, wherein the base component comprises a bottom and a pair of opposing side walls which form sides of the shoe.

3. The doorstopper device of claim 2, wherein the base component comprises a back wall which forms a heel portion of the shoe and a front wall which forms a toe and a tongue portion of the shoe.

4. The doorstopper device of claim 3 wherein the back wall, the pair of opposing side walls, and the front wall come together to form a circular opening at a top of the doorstopper device.

5. The doorstopper device of claim 4, wherein the front wall and the pair of opposing side walls near the toe portion of the shoe are inclined, such that they gradually-increase inclination from the bottom to the top of the shoe.

6. The doorstopper device of claim 5, wherein the gradual inclination allows the doorstopper device to be inserted under and to engage the lower edge of the door.

7. The doorstopper device of claim 1 further comprising a sole component secured to the base component to keep the doorstopper device in place under the door.

8. The doorstopper device of claim 7, wherein the sole component comprises a vulcanized rubber, non-slip material for contacting the floor surface.

9. The doorstopper device of claim 8, wherein the vulcanized rubber, non-slip material comprises a plurality of lateral corrugations that form teeth.

10. The doorstopper device of claim 9, wherein the base component and the sole component are manufactured from the same material.

11. The doorstopper device of claim 9, wherein the base component and the sole component are integrally formed.

12. The doorstopper device of claim 1, wherein the doorstopper device can be shaped as a sandal, a flip flop shoe, a wedge shoe, a tennis shoe, a slip-on show, a Mary Jane shoe, a moccasin, a cleat, a loafer, a boot, a baby booty, a high heel, an athletic shoes or a sneaker.

13. The doorstopper device of claim 1, wherein the base component comprises a plurality of accessory components to make the base component more resemble a shoe.

14. A doorstopper device adapted to be inserted between a lower edge of a door and a floor surface, the doorstopper device comprising:
a base component; and
a sole component secured to the base component to keep the doorstopper device in place under the lower edge of the door;
wherein the base component is shaped like a shoe;
wherein the base component comprises a bottom and a pair of opposing side walls which form sides of the shoe;
wherein the base component comprises a back wall which forms a heel portion of the shoe and a front wall which forms a toe and a tongue portion of the shoe;
wherein the bottom wall is generally flat and extends an entire length of the doorstopper device and constitutes a bottom of the doorstopper device; and
further wherein a top of the doorstopper device comprising the front wall forms a wedge-shaped surface extending from a toe portion to the heel portion, which allows the doorstopper device to engage the lower edge of the door and allows the doorstopper device to be inserted under the door.

15. The doorstopper device of claim 14, wherein the sole component comprises a vulcanized rubber, non-slip material for contacting the floor surface.

16. The doorstopper device of claim 14, wherein the base component and the sole component are manufactured of the same material.

17. The doorstopper device of claim 14, wherein the base component and the sole component are manufactured as a single unit.

18. The doorstopper device of claim 14 wherein the doorstopper device is shaped like a sandal, a flip flop shoe, a wedge shoe, a tennis shoe, a slip-on shoe, a Mary Jane shoe, a moccasin, a cleat, a loafer, a boot, a baby booty, a high heel, an athletic shoe or a sneaker.

19. The doorstopper device of claim 14 further comprising a plurality of indicia.

20. A method of keeping a door propped open for entry or ventilation, the method comprising the steps of:
providing a doorstopper device comprising a base component with a non-slip vulcanized rubber sole component;
choosing a specific style and size of the doorstopper device, depending on the needs and/or wants of a user;
positioning the doorstopper device underneath the lower edge of a door and the floor; and
keeping the door propped open via the doorstopper device.
